(19) United States
(12) Patent Application Publication
(10) Pub. No.: US 2009/0191415 A1
(43) Pub. Date: Jul. 30, 2009

(54) SAFE TEMPERATURE CONNECTION FOR COMPONENTS

(75) Inventors: Bruce W. Anderson, Andover, MN (US); Douglas R. Carlson, Woodbury, MN (US); Lisa Lust, Plymouth, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/022,457

(22) Filed: Jan. 30, 2008

(51) Int. Cl. B32B 15/04; B32B 37/14

(52) U.S. Cl. 428/457; 156/60; 428/411.1

(57) ABSTRACT

A connection made between components at a safe temperature for each of the components. A slot made may be provided on one component and a tab provided on the other component. The slot may be filled with an electrically conductive material. The tab may be inserted in the slot before significant curing of the material and kept in the slot throughout the curing period of the material. The curing may be effected at a temperature harmless to the components. For example, the temperature may be room temperature. One example of a temperature-sensitive component may be a thin battery.

The U.S. Government may have certain rights in the present invention.

### BACKGROUND

The invention pertains to electrical components and particularly to temperature sensitive components. More particularly, the invention pertains to making electrical connections among the components.

### SUMMARY

The invention is for connecting, without harm, one or more temperature sensitive components to another component.

### BRIEF DESCRIPTION OF THE DRAWING

FIG. 1 is a diagram of an interconnection of two components;

FIG. 2 is a diagram of a component having terminals set-up for a temperature-safe connection with another component; and

FIGS. 3a through 3e are diagrams of a sequence for attaching one component to the other component under temperature safe conditions.

### DESCRIPTION

Issues may arise when attempting to solder, for instance, thin film batteries with dissimilar metal electrodes and corresponding tabs to circuit boards. The heat from most soldering techniques may damage many thin batteries. The dissimilar metals on the tabs require different soldering techniques requiring higher than normal soldering temperatures. A question is how to attach thin batteries to circuit boards without damaging the batteries themselves. The circuit boards, for instance, may be thin film flexible circuit boards.

The present invention is an approach for connecting batteries to circuit boards which solves the problem of damaged batteries during the assembly. Removing heat from the process of connecting the batteries has shown to result in an improvement in life of the battery.

When batteries are supplied with one copper electrode and one aluminum electrode, a technique may be needed to connect the battery to the circuit boards. A solution may include using a conductive epoxy which cures at room temperature to connect the battery to the circuit board and then wrapping the connection in such a way that the connection is protected from the stresses of flexing.

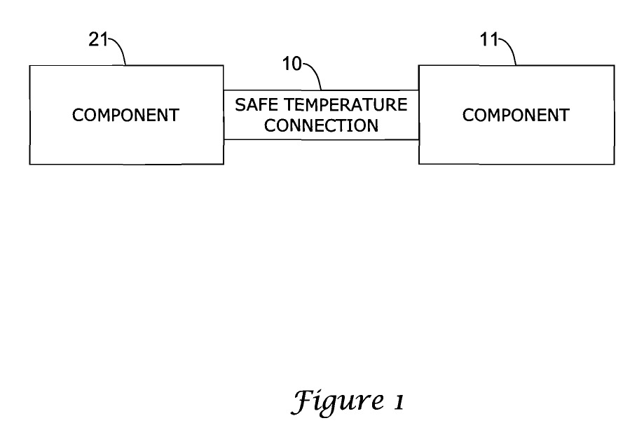

FIG. 1 shows components 11 and 21 having a connection 10 which may be effected under temperatures that result in no damage or harm to either component. Damage or harm may include degradation or lifetime reduction of a component, such as a battery. A temperature, which results in no damage or harm to either one of the components being connected, may be regarded as a safe temperature. The safe temperature may vary from one component to another. That means if one or more components are sensitive to and consequently can be harmed by a temperature that is too high or too low, such temperature is not a safe temperature. For example, a temperature resulting from heat due to soldering of a connection to the component that is harmful to one of the components common to the connection is not a safe temperature. So then another approach for connecting may be needed that can be achieved at a temperature which is not harmful to any of the components being connected. Room temperature may be regarded as a safe temperature for achieving connections among many components. Room temperature may be regarded herein as ranging about between 18 degrees C. (64 degrees F.) and 30 degrees C. (86 degrees F.). However, a safe temperature may be higher than room temperature since a higher temperature might not harm any of the components associated with an effecting a connection between or among them; however, soldering temperatures may yet be way too high for many component connection applications.

Temperatures for melting solder may range from about 180 degrees C. to 250 degrees C., depending on the kind of solder used. The lead-free solder may be a higher temperature solder. Soldering mechanisms, such as tips, may need temperatures from about 200 degrees C. to 400 degrees C. for effective soldering. These temperatures may degrade certain components while being connected with solder. If one used solder with a 180 degree C. melting point (which may be a kind of solder having one of the lower melting points), the component may be heated well above 180 degrees C. (e.g., 200+ degrees C.) to attain an effective solder connection. The lower the temperature of the component for a given solder melting point, then the longer time the component is at that temperature. The higher the temperature of the component for a given solder melting point, then the shorter time the component is at that temperature. Depending on the component, a longer time at a lower temperature may be as harmful as a shorter time at a higher temperature.

Thus, other connecting materials, such as electrically conductive epoxies, may cure at 100 degrees C. within 15 minutes hour or at 23 degrees C. within 24 hours. These may be the maximum temperatures to which the components may be subject since the heating of the component for curing need not exceed the actual cure temperature.

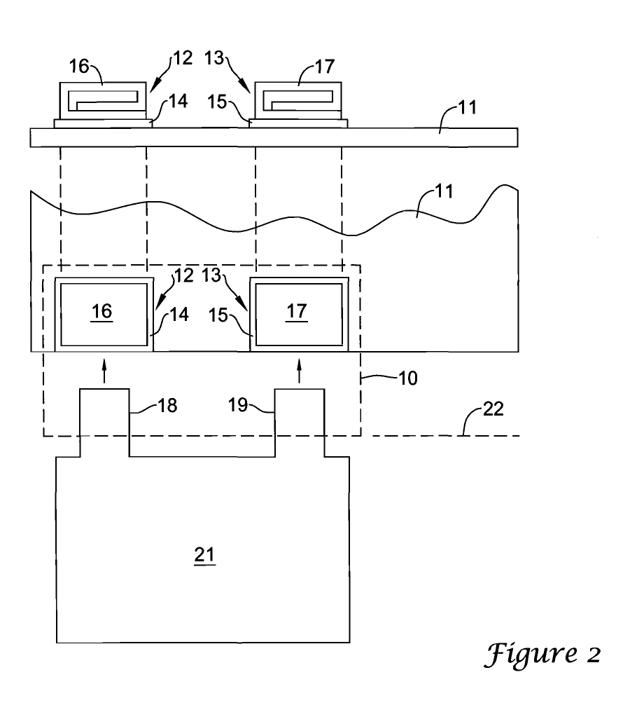

FIG. 2 shows a board 11 having two terminals 12 and 13 for receipt of electrical power for circuitry on board 11. Circuit board 11 may have two pads 14 and 15 for receiving power to operate the electronics or the like on the board 11. A piece of copper strip may be wrapped about itself to form a socket-like or slot-like device 16 for insertion of a plug terminal or tab 18 of a battery, power source or other electrical component 21. Component 21 may be heat sensitive, so the approach for secure connection of the component to the board 11 should not subject component 21 to very hot conditions such as 180 degrees C. Device 16 may be referred to as a slot 16 in the present description although it may be one of other kinds of mechanisms for achieving connection. The plug terminal or tab may be referred to a tab 18 herein. The tab may be of a metal dissimilar to the metal of the strip. For instance, the tab may be aluminum. The copper strip may be thin and be soldered at the ends to form the loop of the slot 16. Also, the looped copper strip may be affixed to the pad 14 with solder or other material. The width of the copper strip of slot 16 may be slightly shorter than the length of the tab 18. These dimensions may be in the same direction. The fabrication, makeup and description of socket-like or slot-like device 17 relative to pad 15 and a plug terminal or tab 19 may be similar to that of device 16 relative to tab 18. The dashed line rectangle may indicate the connection 10 incorporating the slots and tabs.

The diagram of FIG. 2 is not necessarily proportional in scale but is illustrative for showing an example of component elements. The metal of devices 16 and 17 and pads 14 and 15 may be copper but could be another kind of metal. For example, the pads may be gold. Soldering similar metals may result in temperatures harmful to one of the components 21 and 11. Soldering dissimilar metals may result in temperatures higher than the temperatures resulting from soldering similar metals. Connecting certain metals or dissimilar metals may require brazing or even welding, resulting in still even higher temperatures.

The tabs 18 and 19 may be inserted nearly all of the way with a portion of the tabs near the component 21 not inserted in the slots 16 and 17, respectively. This may permit flexibility of an electrical source or component 21 to move about an axis parallel to the near the edge of the source 21 as indicated by a dashed line 22. In other words, relative to a plane of board 11, the component 21 may flop up and down in and out relative to the sheet of FIG. 1. The tabs 18 and 19 generally may be inserted into the slots 16 and 17 just short of the dashed line 22. At this stage of connection of component 21 to board 11, the tabs 18 and 19 and component 21 have not been subject to heat much more than ambient room temperature about the board 11 and component 21.

For a permanent connection of tabs 18 and 19 inserted in slots 16 and 17, respectively, solder is not used because of the heat which may be generated could be harmful to source 21. Even if solder were used, special techniques involving possibly much greater heat than that of normal soldering may have to be resorted for electrically connecting a tab 18 or 19 to a slot 16 or 17, respectively, because of at least one tab being of a metal dissimilar to the metal of the slot that the tab is being mated to. The tab metal may be aluminum and the slot may be copper. The metals of the tabs 18 and 19 and the slots 16 and 17 may be of various kinds and combinations relative to respective mating of the tabs, prongs or projections to the slots or socket-like devices.

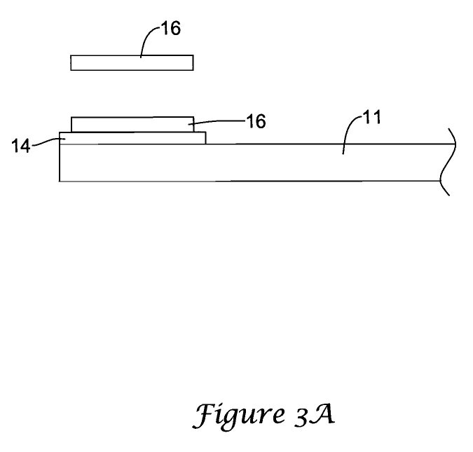

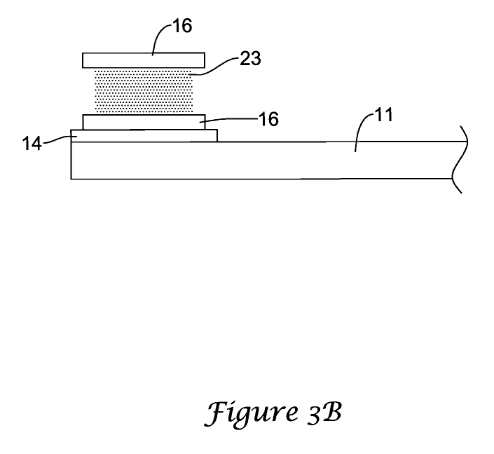

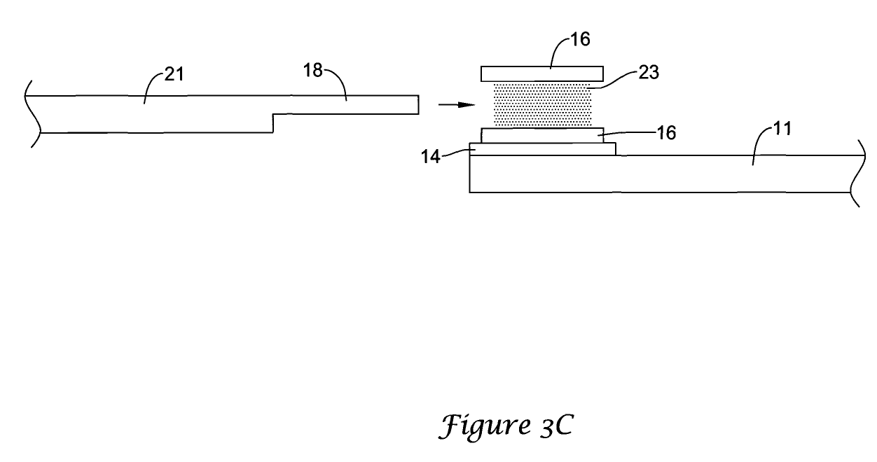

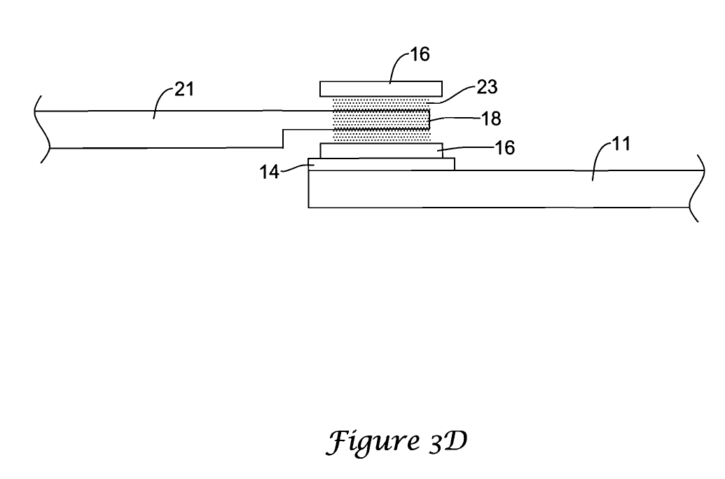

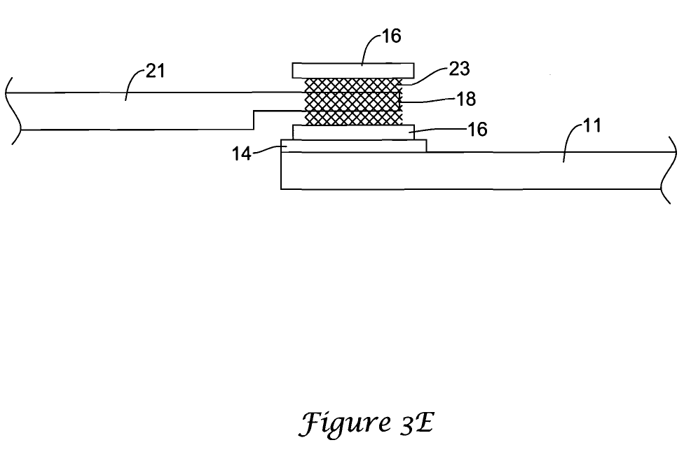

FIGS. 3a through 3e show an approach of mating a tab to a slot without heat and resulting in a mechanically and electrically secure connection between the tab of source 21 and the mated slot. For instance, one may look at the procedure for tab 18 and slot 16. This procedure is likewise applicable to tab 19 and slot 17.

FIG. 3a is a side cross-section view of slot 16 affixed to pad 14 on circuit board 11. FIG. 3b shows the same structure FIG. 3a except the space within the hole or cavity has some material 23 within slot 16. An epoxy 23 may be placed in slot 16 to fill up or displace some of the space within the hole or cavity within the slot 16. The epoxy 23 may be electrically conductive which cures at room temperature in about one day (i.e., about 24 hours). It may have a paste-like viscosity. The epoxy may be a two-component or one component mixture. The resultant mixture may comprise silver particles for the electrical conductive purposes. An example of epoxy 23 which can be used may be EPO-TEK™ EE129-4 OR E415G, available from Epoxy Technology, Inc. of Billerica, Mass. This example epoxy may cure in about 24 hours at about 23 degrees C. Other electrically conductive materials with various properties such as cure temperatures and times may be commercially available.

FIG. 3c shows the epoxy-filled slot 16 of FIG. 2c but with a tab 18 of component 21 being aligned for insertion into the epoxy 23 in the slot 16. FIG. 2d shows tab 18 being inserted into the opening of slot 16 filled with the epoxy 23 generally before the epoxy has substantially started to cure. Then tab 18 may be held in position for a prescribed period of time, such as for example, 24 hours, to obtain a cure of the epoxy 23 at room temperature. The cure may be accelerated at a higher temperature that does not harm any of the components such as source 21. FIG. 2e represents the tab 18 as firmly secured in and electrically connected to slot 16 with a cured epoxy 23.

The component 11 may be a flexible circuit board with a 0.5 mil polyimide layer plated on both sides with about 9 microns of copper for a total of thickness less than 31 microns. The height of the slots 16 and 18 above the surface of board 11 may be less than 50 microns (2 mils). The source 21 may be a thin battery having a thickness less than 5 mils (130 microns). These dimensions are examples for illustrative purposes. Other dimensions may be applicable. Source 21 may be a thicker battery (i.e., >5 mils) and still be susceptible to harm from high temperatures.

The circuitry on board 11 may include thin film components. The circuit board 11 and source 21 may eventually be encapsulated as a single unit. The present connector scheme with slots 16 and 17 having epoxy 23 secured tabs 18 and 19, respectively, may be applicable to various other kinds of connection configurations and technologies. The slots 16 and 17 and tabs 18 and 19 may be substituted with equivalent components using the same or other kinds of component-safe-temperature materials for connection and conduction.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A method for connecting components comprising:
providing a first component with a first terminal;
providing a second component with a second terminal;
placing an electrically conducting material on the first terminal;
placing the second terminal in contact with the electrically conducting material; and
curing the electrically conducting material at a safe temperature that does not result in damage to the first or second component.

2. The method of claim 1, wherein a safe temperature is room temperature.

3. The method of claim 2, wherein room temperature is about between 18 degrees C. and 30 degrees C.

4. The method of claim 3, wherein the electrically conducting material is an epoxy.

5. The method of claim 4, wherein the epoxy has a curing period of approximately one day at room temperature.

6. The method of claim 4, wherein:
the first terminal comprises a first metal;
the second terminal comprises a second metal; and
the first and second metals are dissimilar metals.

7. The method of claim 6, wherein:
the first component is a thin circuit; and
the second component is a thin battery.

8. An electronic system comprising:
a first component; and
a second component having an electrical connection to the first component; and
wherein the electrical connection is achieved at a temperature equal to or less than a temperature that is safe for the first and second components.

9. The system of claim 8, wherein the connection is achieved with an electrically conducting material.

10. The system of claim 9, wherein the electrically conducting material cures at a temperature equal to or less than a temperature that is safe for the first and second components.

11. The system of claim 10, wherein the electrical connection comprises:
a first terminal attached to the first component; and
a second terminal connected to the second component; and
wherein the second terminal is connected to the first terminal with the electrically conducting material.

12. The system of claim 11, wherein:
the first terminal is a strip of metal formed into a slot which is attached to the first component;
the slot contains the electrically conductive material; and
the second terminal is a tab inserted in the slot before a substantial curing of the material.

13. The system of claim 12, wherein:
the first component is a flexible circuit board; and
the second component is a thin battery.

14. A system having at least one connection, comprising:
a first component having a first terminal;
a second component having a second terminal; and
a connection between the first terminal and the second terminal; and
wherein the connection is achieved at a temperature not harmful to the first component and the second component.

15. The system of claim 14, wherein the first terminal and the second terminal are connected with an electrically conductive adhesive.

16. The mechanism of claim 15, wherein the electrically conductive adhesive is curable at a temperature not harmful to the first component and the second component.

17. The system of claim 14, wherein:
the first terminal is a projection;
the second terminal is a slot filled with an electrically conductive adhesive;
the projection is inserted into the slot before a substantial curing of the electrically conductive adhesive; and
the projection remains in the slot through the substantial curing of the electrically conductive adhesive.

18. The mechanism of claim 17, wherein:
the projection comprises a first metal;
the slot comprises a second metal; and
the first metal and the second metal are dissimilar.

19. The mechanism of claim 14, wherein:
the first component is an electrical power source;
the second component is an electrical load;
one of the first and second terminals is a tab;
another one the first and second terminals is a slot;
the slot comprises an electrically conductive material; and
the tab is inserted in the slot having the electrically conductive material prior to a significant curing of the material.

20. The system of claim 19, wherein the electrically conductive material cures at about or less than the temperature which is not harmful to the first component and the second component.
